(19) United States
(12) Patent Application Publication
(10) Pub. No.: US 2024/0144726 A1
(43) Pub. Date: May 2, 2024

(54) INTERACTIVE SYSTEM FOR IDENTIFICATION AND TRACKING OF OBJECTS AND GESTURES

(71) Applicant: The Last Gameboard, Inc., Denver, CO (US)

(72) Inventors: Travis PORTER, Denver, CO (US); Shail MEHTA-SCHUKAR, Denver, CO (US); Tim SCHUKAR, Denver, CO (US)

(21) Appl. No.: 18/052,161

(22) Filed: Nov. 2, 2022

(51) Int. Cl. G06V 40/20; G06F 3/044; G06T 5/00; G06T 7/13; G06T 7/246; G06T 7/50; G06T 7/64; G06V 10/30; G06V 10/44; G06V 10/77

(52) U.S. Cl. CPC G06V 40/28; G06F 3/044; G06T 5/002; G06T 7/13; G06T 7/248; G06T 7/50; G06T 7/64; G06V 10/30; G06V 10/44; G06V 10/7715; A63F 3/00643; G06T 2200/24; G06T 2207/20212; G06T 2207/30196

(57) ABSTRACT

Implementations described and claimed herein include a system including a grid of plurality of projected capacitance (PCAP) sensors, wherein each of the plurality of PCAP sensors is configured to generate time-series of heat data related to a pixel on the grid, a pre-processing module configured to receive a vector of heat map data and remove noise from the heat data, a contour detection module configured to detect contours of one or more objects, and a feature extraction module configured to extract one or more features from the contours of one or more objects and to generate an input vector for a machine learning model, wherein the machine learning model is configured to identify the one or more objects.

### SUMMARY

Implementations described and claimed herein include a system including a grid of plurality of projected capacitance (PCAP) sensors, wherein each of the plurality of PCAP sensors is configured to generate time-series of heat maps that represent levels of capacitance, a pre-processing module configured to receive a vector of heat map data and remove noise from the heat map data, a contour detection module configured to detect contours of one or more objects, and a feature extraction module configured to extract one or more features from the contours of one or more objects and to generate an input vector for a machine learning model, wherein the machine learning model is configured to identify the one or more objects or gestures.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates an example implementation of the interactive system 100 for identification and tracking of objects and gestures.

FIG. 2 illustrates example of shapes that can be identified by the interactive system disclosed herein.

FIG. 3 illustrates an example image of a PCAP heatmap for a hand of a player.

FIG. 4 illustrates an example token that is represented by heatmaps when it is placed on a PCAP sensor.

FIG. 5 illustrates example of tracking various objects across difference frames over time.

FIG. 6 illustrates example post processing of objects identified by ML models.

FIG. 7 discloses example operations that may be used by the system disclosed herein for providing shape and gesture recognition.

FIG. 8 illustrates an example processing system that may be useful in implementing the technology described herein.

### DETAILED DESCRIPTIONS

The technology disclosed herein provides an interactive system for shape and gesture recognition. The shapes may be capacitive or non-capacitive, such as ceramic coffee mugs, etc. Specifically, the system provides physical tokens and gestures to be used for interactive systems. In disclosed implementations, heatmap data from a projected capacitance (“PCAP”) sensor is ingested and processed for tracking and identification of touches and objects. Subsequently, contours are gathered from the data and calculations are made on the contours and fed into a machine learning (ML) model. This model provides identification via a library of known shapes. The current data is compared to the history to correlate old data to new data for tracking purposes. Implementations disclosed herein rely on very low level of capacitive differences and utilizes such low levels of differences to determine presence of objects or touch. Therefore, the system disclosed herein allows using very low levels of capacitive differences to determine presence of objects or touch, whereas other system usually discard such low level information as noise by filtering it out.

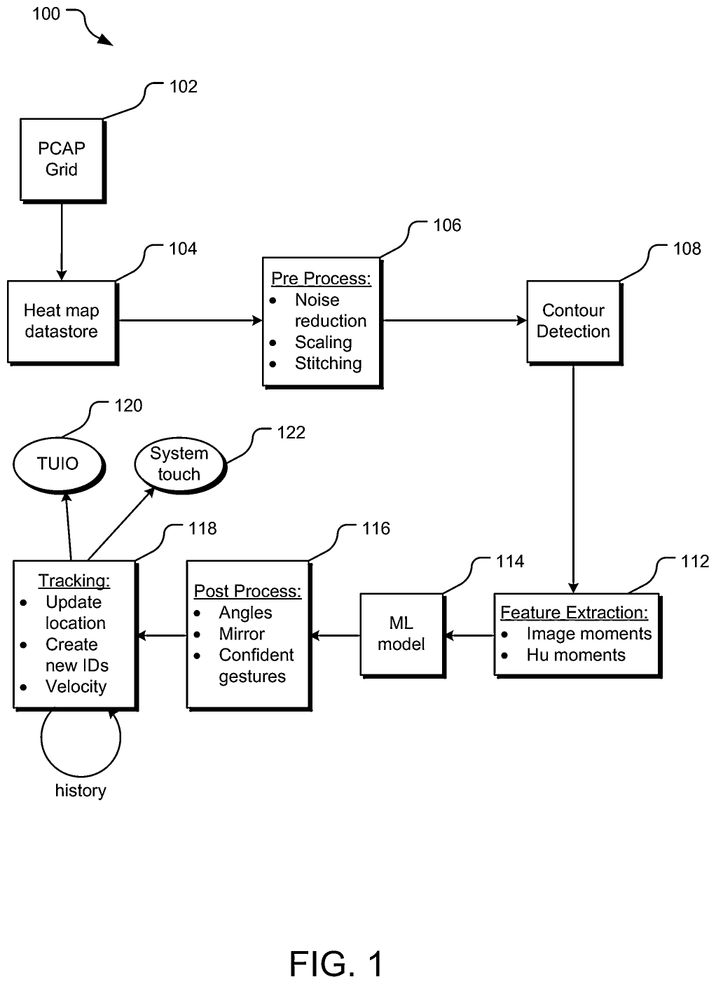

FIG. 1 illustrates one implementation of the interactive system 100 for identification and tracking of objects and gestures. A grid of plurality of projected capacitance (PCAP) sensors 102 generates heat map data for a heat map data store104. In one implementation, the PCAP grid 102 may be configured on an interactive gameboard. Alternatively, the technology disclosed herein may also be used for other displays and surfaces with objects, such as a conference table with objects, a picture frame, etc. For example, the interactive gameboard may have a PCAP grid 102 where each of the PCAPs of the PCAP grid is configured at a particular pixel on the interactive gameboard. In one implementation, the PCAP grid may be a square grid of 120×120 pixels. However, in alternative implementations, the PCAP grid 102 may be of alternative shape, such as a rectangular, circular, triangular, polygon, and/or with alternative number of pixels in each dimension. In one implementation, each of the PCAP sensor if the PCAP grid 102 is configured to generate mutual capacitance at its respective pixel.

In one implementation, the PCAP grid 102 includes a number of PCAP sensors and the grid is configured to generate a time-series of 3-D heat data frames with each of the 3-D heat data frame including heat data related to a 2-D array of pixels on the grid on the surface of the PCAP sensors and at discrete “z” levels above the PCAP sensors.

The PCAP values generated by the PCAP grid 102 may be stored in a heat map data store 104. Specifically, the heat map may datastore 104 may have a time-series data from each of the sensors from the PCAP grid. Thus, if the PCAP grid 102 is configured on a gameboard, the heat map datastore 104 may have time series of heat map data for a vector of sensors from the PCAP grid 102. For example, in one implementation, each of the sensors on the PCAP grid 102 generates a heat map data related to its respective pixel 150 times a second. However, in alternative implementations, more or less number of sensor data may be captured per second at each pixel.

The heat map data from the heat map data store 104 may be communicated to a pre-processing module 106 that performs a number of operations to pre-process the heat data. For example, the pre-processing module 106 may remove the noise from the heat data. In one implementation, such removal of noise may include drift compensation in the heat of data for each pixel. The drift compensation adjusts for all pixels getting brighter over time as the PCAP grid heats up over time. In one implementation, drift compensation may be used to counteract or correct for the thermal changes in the PCAP sensor over time. Specifically, such drift compensation may include adjusting data for each pixel such that the upward drift in the heat data over time is compensated. In one implementation, the drift compensation may include averaging out all pixels that are determined to be close to black. For example, the pre-processing module 106 looks at the values of all pixels in the data grid for pixels that may indicate noise and values close to black values, while ignoring shapes/touches. Subsequently, the values of such pixels indicating noise is averaged and the average is subtracted from every pixel in the grid data. Such drift compensation gives a floor to the noise in the data grid.

In an alternate implementation, such drift compensation may include calculating an average increase in heat across all pixels and subtracting such average increase in the heat from the observed heat values for each pixel. In alternative implementation, the individual heat data for each pixel is adjusted so that the average heat value for all pixels of the heat map is zero without compensating for any touches to the gameboard generating the heat map data.

In another alternative implementation, the heat map data from various frequency columns of the heat data is adjusted for noise on each of these frequency columns as well. For example, the pre-processing module 106 may determine which frequency column has noisy data and can blank out the data from such noisy frequency column and substitute the average of the two heat data from the two adjacent columns to the noisy frequency column. For example, if the heat data in frequency column for 305 Hz is determined to be noisy, the average heat data from two pixels from the frequency column for 304 Hz and 106 Hz substituted for the pixel data for the frequency column for 305 Hz.

In one implementation where the heat data includes more than one component grid, such as for example, two component grids of 120×60 PCAPs, the pre-processing module 106 may also stitch the data from the two grids. Each grid may have an identification in firmware so the stitching will be done on known boundaries. In one implementation, the independent grids are synchronized with frame numbers, to reduce the tearing along boundaries and distortion of the shapes. Alternatively, the PCAP grid 102 may be divided into a different number of component grids such as for example eight component grids, twenty component grids, etc., and the pre-processing module 106 stitches the data from these large number of component grids. The capability to stich data from large number of component grids allows the system 100 to scale up to a large sizes for data sources. In one implementation, the data grid 102 is also configured to read heat map data in discrete planes “z” distance above the surface of a PCAP sensor.

Additionally, in one implementation, the pre-processing module 106 also scales the heat map data. Specifically, the pre-processing module 106 upscales the data such that objects sensed by the PCAP grid 102 are easier to detect. Thus, for example, the data from the grid of 120×120 may be upscaled at the grid level so that the total number of observations in the grid are 240×240. Such upscaling of the data allows for better detection of objects such as thumbs, fingers, etc. In one implementation, the upscaling may include interpolating data points using adjacent data points. For example, such interpolating may be achieved using bicubic interpolation.

The heat data processed by the pre-processing module 106 is input into a contour detection module 108 that detects contours of various objects. For example, if the PCAP grid 102 is implemented on a gameboard where one or more objects are placed, the contour detection module 108 detects contours of such objects. Alternatively, if the data grid 102 is configured on a surface that is expected to have touch by a user, the contour detection module 108 detects contours of the user's finger, thumb, touch pen, etc. In one implementation, the contour detection module 108 may use a contour detection algorithm, such as the findContours algorithm that retrieves contours from the pre-processed grid data. Such contours are used to detect and analyze shape of objects on PCAP grid 102. The output of the contour detection module 108 may be a number of arrays where each array has (x,y) coordinates of boundary points of an object. For example, one such array may include boundary points of user's thumb, another such array may include boundary points of an object on a gameboard, etc.

Alternatively, if the data grid 102 is configured to read heat map data in discrete planes “z” distance above the surface of the PCAP sensor, a virtual three dimensional space that is expected to have touch by a user, the contour detection module 108 detects 3D histogram contours of the object by curve fitting between the discrete heat map layers in which the object is interacting. In one implementation, the contour detection module detects 2-D contours of one or more objects at each of the discrete “z” levels and connects points of the 2-D contours at each of the discrete “z” levels to points on the 2-D contours of other of the one or more of the other “z” levels to generate 3-D contours of the one or more objects.

The output from the contour detection module 108 are input to a feature extraction module 112. The feature extraction module 112 extracts image moment invariants for the various 3-D contours output from the contour extraction module 108. Such image moment invariants may be certain particular weighted average moments of the intensities of pixels of images identified by the contours. In one implementation, the image moment invariants generated by the feature extraction module 112 extracts rotational moment invariants, known as Hu moment invariants. Specifically the Hu moment invariants 1-6 are extracted. As Hu moments 1-6 are rotational invariant, their value does not depend on the rotational state of the objects. Thus, for example, an object with a rectangle shape can be oriented at a number of different rotational angles on the PCAP grid 102, however, irrespective of its rotational angle, its Hu moments 1-6 are same in each rotational state.

Furthermore, the feature extraction module 112 also extracts the 7^{th} Hu moment as it indicates whether an object is in a mirror state on the PCAP grid. This is used to determine whether a user's hand on or near the PCAP grid 102 is a left hand or a right hand. Because these image moments are size invariant in that their values do not depend on the size of the shapes, the feature extraction module 112 also extracts additional parameters from the image contours that are used to determine the sizes of different shapes. For example, the feature extraction module 112 determines the arc length of the shapes so that the total length of the object can be determined. The feature extraction module 112 also determines the area of the shapes, the total number of sides of the shape, etc.

Additionally, the feature extraction module 112 also determines if there are any nested contours identified by the contours generated by the contour detection module 108. For example, determining the nested contours allows determining whether the contours indicate a hollow circle vs a filled circle as a hollow circle appears as two contours, one outer contour and one slightly smaller inner contour. On the other hand, if the circle were a filled circle, there is only one outer contour.

The parameters generated by the feature extraction module 112, including the Hu moments of the shapes, the size of the shapes, the arc length of the shapes, the number of sides of the shapes, the orientation of the shapes, the hollowness parameter of the shapes, the parameter indicating the front of the share, etc., are used to generate an input vector for a support vector machine (SVM), a neural network (NN), or other machine learning (ML) model 114.

The output of the ML model 114 provides shape classification and the confidence of the shape. For example, from a list of known shapes, the ML model may list various shapes and all the confidence values of each of the various shapes. In one implementation, the input vector of the features is input to the ML model 114 to train the ML model. In another implementation, where the ML model 114 is already a trained model, the input vector is entered into the trained ML model to generate a series of temporal output frames, where each frame may be a data structure including arrays of various shapes. The shape arrays in the temporal frames may identify custom-made in-house shapes of tokens used on a gameboard, a user's hand or palm, user's fingers, etc. In one implementation, each frame is a two dimensional array. For different z heights, each frame may be another two dimensional array. As a result, when combined for volume shape identification, this results in a three dimensional array.

The output of the ML model 114 is input into a post-processing module 116. In one implementation, the post-processing module 116 determines the orientation of the shapes indicated by the contours. In an implementation, the orientation v of a given shape may be determined based on the equation 1 below:

$$Θ \frac{1}{2} ( \frac{2 {μ}_{11}^{′}}{{μ}_{20}^{′} - {μ}_{02}^{′}} )$$

Here the [symbol] ′₁₁, [symbol] ′₂₀ and [symbol] ′₀₂ are respectively the 11^{th}, 20^{th}, and 2^{nd} order image moments of the given shape. Additionally, the feature extraction module 112 also determines the orientation angle of a shape and subsequently, it calculates an offset for a given shape to find the “front” of that given shape.

Additionally, the post-processing module 116 also determines if one or more shapes indicate mirror images by examining image moments 1 through 6 as they are reflection symmetric, and then gives the same values for unmirrored and mirrored shapes. By using image moment 7, the post-processing module 116 also determines if a shape is mirrored or not. Furthermore, the post-processing module 116 also determines confident gestures.

The output of the post processing module 116 is input into a tracking module 118 that tracks various shapes between frames of images based on history of the shapes in various frames. For example, the tracking module 118 tracks location of a hand on the TCAP grid 102 and updates its location. Alternatively, the tracking module 118 may also track various identified objects over time to determine the velocity of the objects, such as for example, a thumb moving at 10 pixels per second in a particular direction, etc. Furthermore, the tracking module 118 also creates IDs for new shapes as they are identified by the ML module 114.

The tracking module 118 generates output for various shapes in the tangible user interface objects (TUIO) protocol 120 as well as other system touch data 122. The data output for module 120 uses the open source TUIO spec (https://tuio.org/). Specifically, the module 118 use the TUIO spec to send the geometry messages to send contour data, token messages to send known shape ids, and frame message to send z-axis values relative to the sensor height. The module 122 may utilize evdev to send events of finger touch data to operating systems.

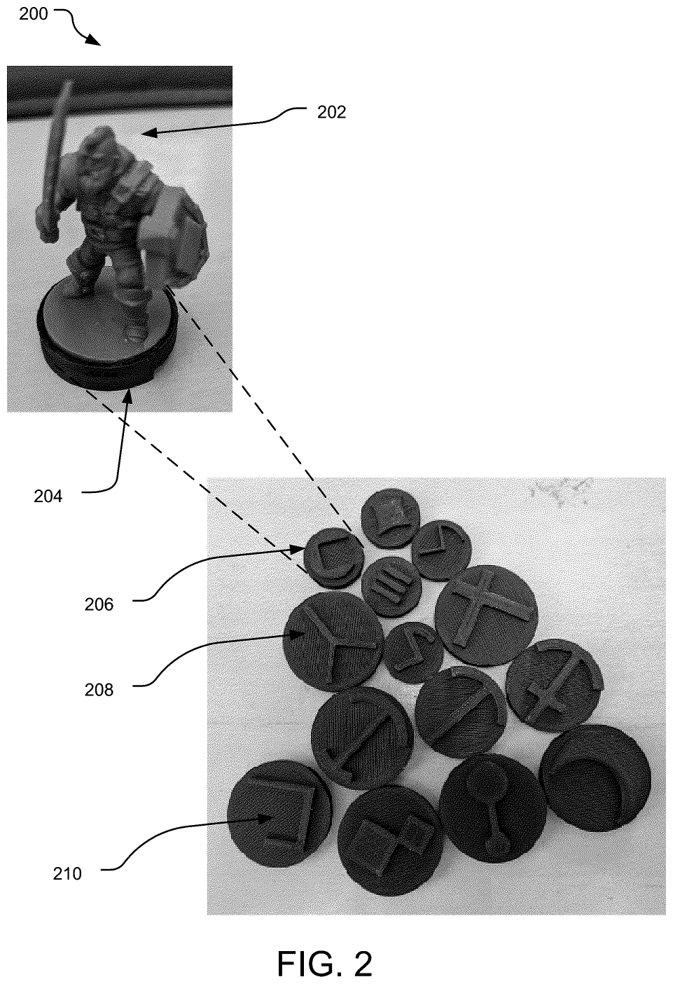

FIG. 2 illustrates example implementation of shapes that can be identified by the interactive system disclosed herein for identification and tracking of objects and gestures. For example, when used with a gameboard, the game piece 202 may be moved by a player on the surface of the gameboard. The game piece 202 may have a base 204 with a particular shape 206 of bottom surface. For example, in the present case, the bottom surface 206 has a shape approximately similar to “C” with edges formed such that this shape is uniquely different from all other bottom shapes 208, 210, etc.

The base 204 of the game piece 202 may be made using various levels of conductive material or of non-conductive material. The shapes 206, 208, 210, have a minimum size based on the pitch of the PCAP sensor. The system disclosed herein supports a large number of different shapes. In one implementation, only the base 204 is made of highly conductive material. Alternatively, the entire game piece 202 can be made with conductive material. When a person is touching the game piece 202, the game piece 202 is grounded creating a larger capacitive. When no person is not touching the game piece 202, a lesser capacitance is observed. Thus, the amount of observed capacitance gives an “on” and “off” state for a person touching the game piece 202.

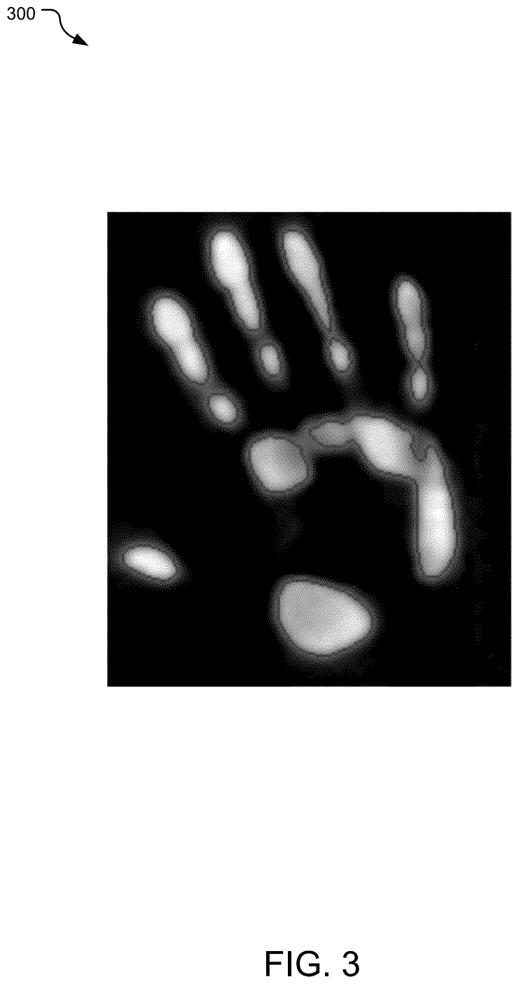

FIG. 3 illustrates an image of a PCAP heatmap 300 for a hand of a player. The PCAP heatmap 300 illustrates capacitive data for each row and column. The PCAP heatmap 300 may be generated by a sensor that has a 120×120 PCAP grid which will contain 14,400 values representing capacitance. The density of the PCAP grid determines how small a token, such as a game piece, can be for detection and tracking purposes. This data is read in real time and fed to multiple algorithms and machine learning models as disclosed above with respect to FIG. 1. In an alternative implementation, a three-dimensional PCAP heatmap may be provided that allows contours to be recognized in 3D, thus allowing for recognition and tracking of much wider range of tokens.

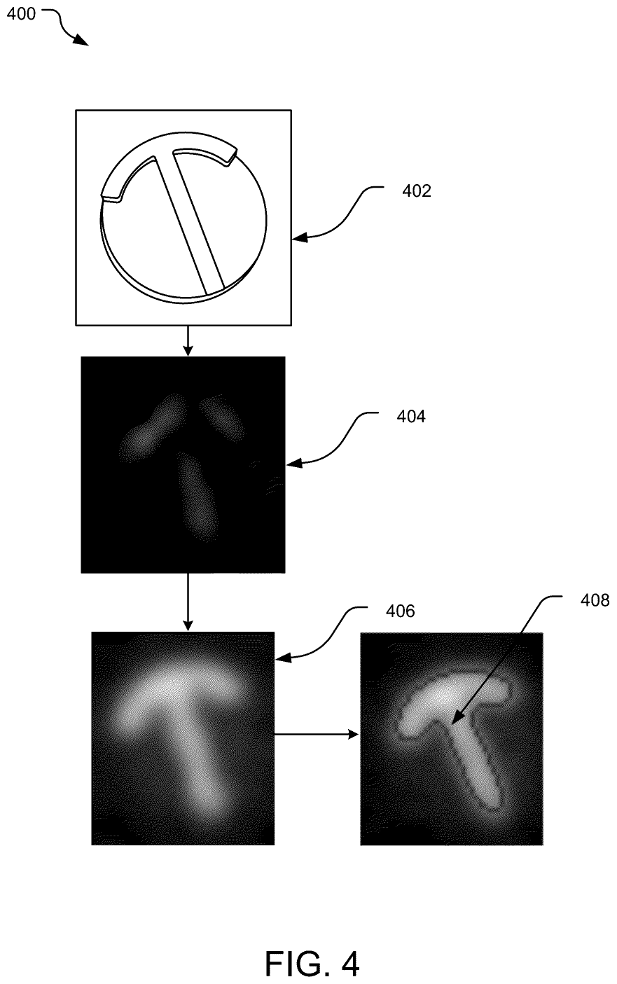

FIG. 4 illustrates a token 402 that is represented by heatmaps when it is placed on a PCAP sensor. The token 402 may be conductive or non-conductive token. As an example, the token may be made of ceramic material that is non-conductive. Specifically, a heatmap 404 represents a non-grounded state when no player is touching the token 402 and a heatmap 406 represents a grounded state when a player is touching the token 402. The contour 408 of the heatmap 404/406 may be generated by a contour generating algorithm such as the findContour function. Using the shape of the contour 408, the system disclosed herein extracts various features that are agnostic to rotation and position of the token, thus resulting in small training data sample. The extracted features, together with other parameters are fed into an ML model that confidence values for each possible shape that is learned into the model.

This technique for detecting shapes of tokens can also be applied to other shapes such as hands, fingers, etc., so that unique shapes of a specific individual hand can be used as an authentication mode to unlock a device or an application.

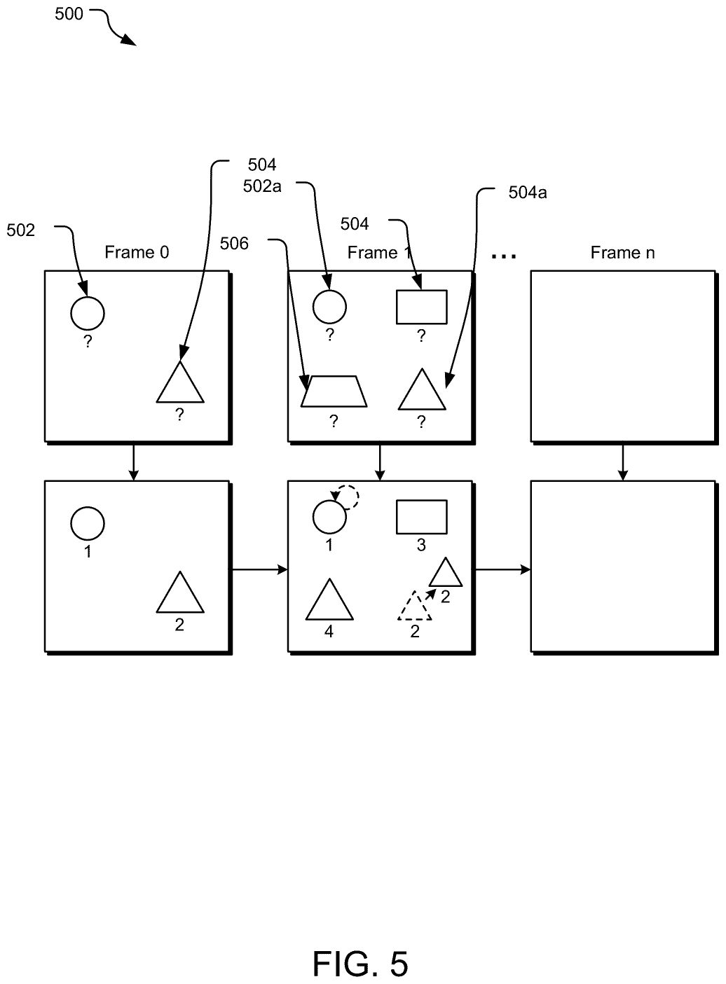

FIG. 5 illustrates tracking various objects across difference frames over time. Specifically, such tracking is done by remembering the history of objects in past frames. Thus, Frame 0 is read in and shapes and are identified. For example, frame 0 includes two detected objects 502 and 504 and they are identified as object 1 and object 2. Then Frame 1 is read in, shapes are identified. For example, in frame 1, four objects 502a, 504a, 506, and 508 are identified. Then the identified shapes from frame 1 are compared to the previous frame 0 to correlate tokens with historical data. This allows for static IDs and velocity calculations. In the given example, given the past information about the object 502 and 504, the objects 502a and 504a are determined to be the same as object 1 and object 2 as detected in frame 0. Such history based identification of objects continues through additional frames.

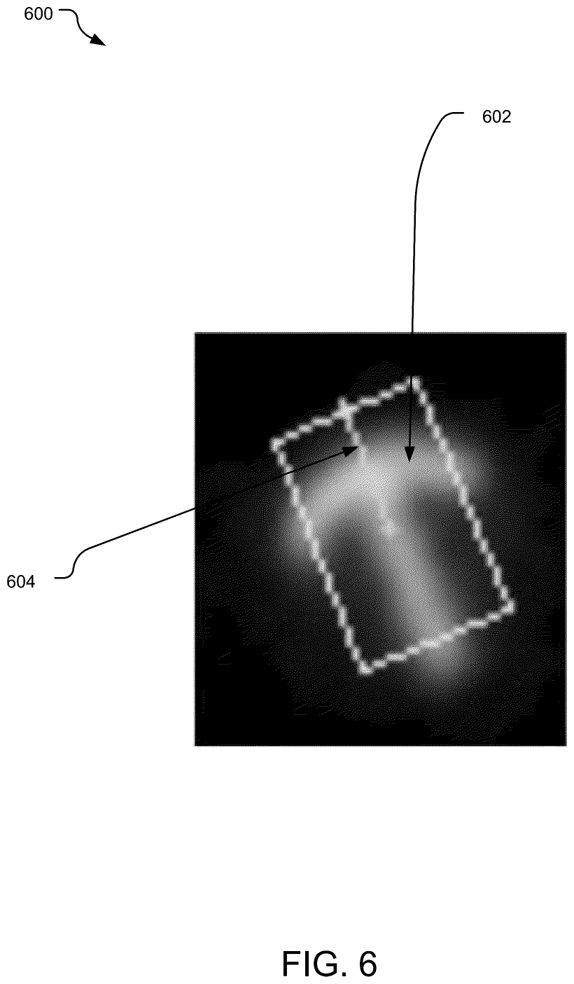

FIG. 6 illustrates post processing of objects identified by ML models. For example, an object 602 is identified with movement in a direction as represented by a line 604. The post-processing of the object 602 may also include detection of mirror image, angle of the object, smoothing of the data, error checking, etc. Such post-processing based on history of movements of the objects allows detecting gestures based on predefined patterns. In one implementation, shapes that are identified as fingers are sent as normal touches to an operating system's touch event driver. On the other hand, other shapes, identified as tokens, are sent out as messages with TUIO data to other applications that can use TUIO information such as contour, shape information, angle, etc., to make one or more decisions.

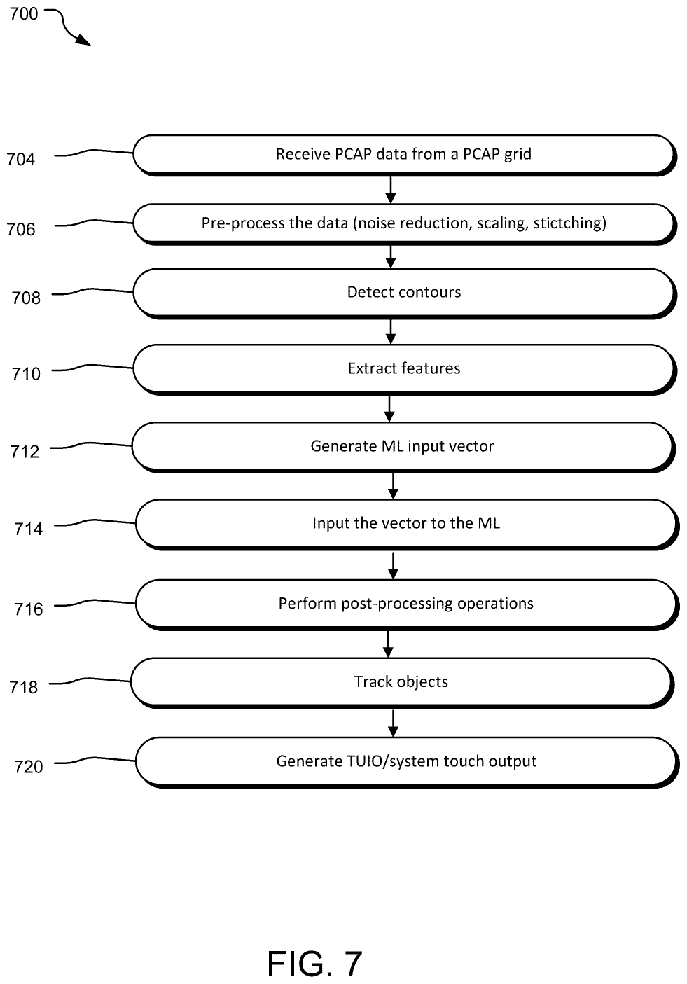

FIG. 7 discloses operations 700 that may be used by the system disclosed herein for providing shape and gesture recognition. An operation 704 may receive PCAP data from a PCAP grid, such as the PCAP grid 102 disclosed in FIG. 1. The PCAP data may include a time-series of 3-D heat data frames, each of the 3-D heat data frame including heat data related to a 2-D array of pixels on the grid on the surface of the PCAP sensors and at discrete “z” levels above the PCAP sensors. Subsequently, an operation 706 pre-processes the 3-D heat data received from the PCAP grid. For example, such pre-processing may include reducing noise, scaling the data, stitching the data, etc. The data output from the pre-processing operation 706 is processed at an operation 708 to detect and output 3-D shape contours. For example, such 3-D shape contours may be in the form of arrays of shape contours.

An operation 710 extracts various features from the 3-D shape contours. For example, such features may be various moments invariants, number of sides of the 3-D shapes, the size of the 3-D shapes, the radii of one or more 3-D shapes, etc. The extracted features may be used by an operation 712 to generate an input vector for a machine learning (ML) model or a support vector machine (SVM). At operation 714, the input vector is input to the ML/SVM to train the model or to a trained ML/SVM model to generate outputs.

The output generated by the ML/SVM model is processed further by a post-processing operation 716. For example, such post-processing may include detection of mirror images, error checking, data smoothing, angle detection, velocity detection, etc. In one implementation, the output from the ML/SVM model is stored in various temporal frames and an operation 718 may track the shapes or various objects across the frames. Finally, an operation 720 generates outputs for system and/or application use. For example, for objects detected on a gameboard, TUIO format output may be generated for use by gaming applications. On the other hand, touch information by user's fingers may be output in a format that can be used by operating system to determine one or more actions, to authenticate users, etc.

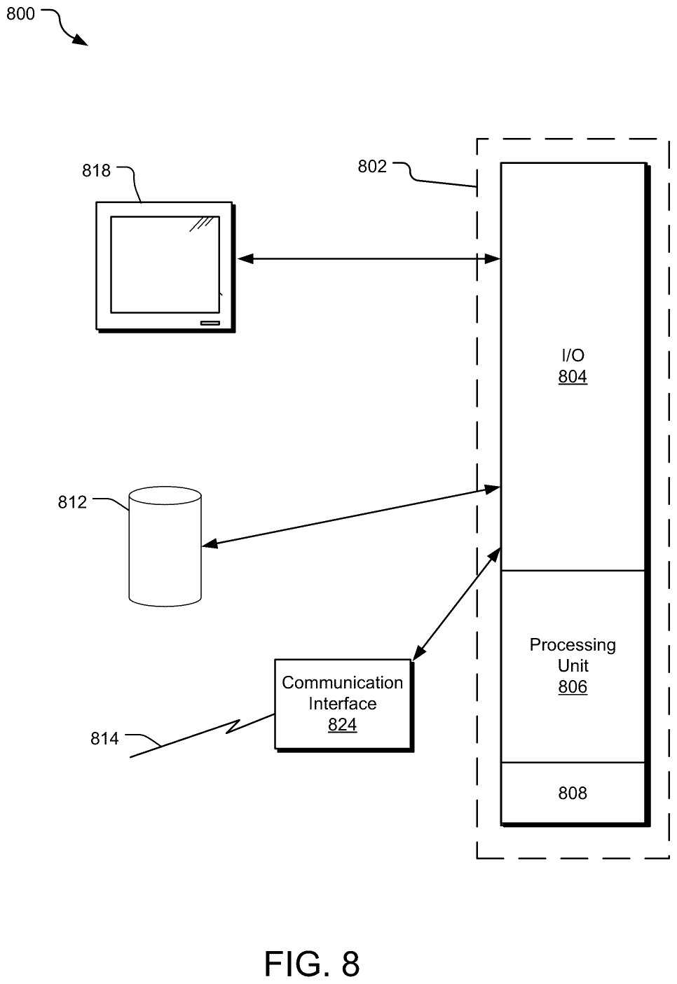

FIG. 8 illustrates an example processing system 800 that may be useful in implementing the described technology. The processing system 800 is capable of executing a computer program product embodied in a tangible computer-readable storage medium to execute a computer process. Data and program files may be input to the processing system 800, which reads the files and executes the programs therein using one or more processors (e.g., CPUs, GPUs, ASICs). Some of the elements of a processing system 800 are shown in FIG. 8 wherein a processor 802 is shown having an input/output (I/O) section 804, a Central Processing Unit (CPU) 806, and a memory section 808. There may be one or more processors 802, such that the processor 802 of the processing system 800 comprises a single central-processing unit 806, or a plurality of processing units. The processors may be single core or multi-core processors. The processing system 800 may be a conventional computer, a distributed computer, or any other type of computer. The described technology is optionally implemented in software loaded in memory 808, a storage unit 812, and/or communicated via a wired or wireless network link 814 on a carrier signal (e.g., Ethernet, 3G wireless, 5G wireless, LTE (Long Term Evolution)) thereby transforming the processing system 800 in FIG. 8 to a special purpose machine for implementing the described operations. The processing system 800 may be an application specific processing system configured for supporting the disc drive throughput balancing system disclosed herein.

The I/O section 804 may be connected to one or more user-interface devices (e.g., a keyboard, a touch-screen display unit 818, etc.) or a storage unit 812. Computer program products containing mechanisms to effectuate the systems and methods in accordance with the described technology may reside in the memory section 808 or on the storage unit 812 of such a system 800.

A communication interface 824 is capable of connecting the processing system 800 to an enterprise network via the network link 814, through which the computer system can receive instructions and data embodied in a carrier wave. When used in a local area networking (LAN) environment, the processing system 800 is connected (by wired connection or wirelessly) to a local network through the communication interface 824, which is one type of communications device. When used in a wide-area-networking (WAN) environment, the processing system 800 typically includes a modem, a network adapter, or any other type of communications device for establishing communications over the wide area network. In a networked environment, program modules depicted relative to the processing system 800 or portions thereof, may be stored in a remote memory storage device. It is appreciated that the network connections shown are examples of communications devices for and other means of establishing a communications link between the computers may be used.

In an example implementation, a storage controller, and other modules may be embodied by instructions stored in memory 808 and/or the storage unit 812 and executed by the processor 802. Further, the storage controller may be configured to assist in supporting the RAID0 implementation. A RAID storage may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 808 and/or the storage unit 812 and executed by the processor 802.

The processing system 800 may be implemented in a device, such as a user device, storage device, IoT device, a desktop, laptop, computing device. The processing system 800 may be a storage device that executes in a user device or external to a user device.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

The embodiments of the disclosed technology described herein are implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the disclosed technology. Accordingly, the logical operations making up the embodiments of the disclosed technology described herein are referred to variously as operations, steps, objects, or modules. Furthermore, it should be understood that logical operations may be performed in any order, adding, and omitting as desired, unless explicitly claimed otherwise or a specific order is inherently necessitated by the claim language.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A system comprising:
a grid of plurality of projected capacitance (PCAP) sensors, wherein the grid is configured to generate a time-series of 3-D heat data frames, each of the 3-D heat data frame including heat data related to a 2-D array of pixels on the grid on the surface of the PCAP sensors and at discrete “z” levels above the PCAP sensors;
a pre-processing module configured to receive a vector of the 3-D heat data frames and remove noise from the heat data;
a contour detection module configured to detect 2-D contours of one or more objects at each of the discrete “z” levels and to connect points of the 2-D contours at each of the discrete “z” levels to points on the 2-D contours of other of the one or more of the other “z” levels to generate 3-D contours of the one or more objects; and
a feature extraction module configured to extract one or more features from the 3-D contours of one or more objects and to generate an input vector for a machine learning model;
wherein the machine learning model is configured to identify the one or more objects.

2. The system of claim 1, wherein each of the plurality of PCAP sensors is configured to generate self and mutual capacitance data related to a pixel on the grid.

3. The system of claim 1, wherein the feature extraction module is configured to extract one or more image moment invariants based on the 3-D contours of the one or more objects.

4. The system of claim 3, wherein the one or more image moment invariants are Hu moments 1-6.

5. The system of claim 4, wherein the input vector for a machine learning model includes the Hu moments 1-6.

6. The system of claim 4, wherein the feature extraction module is configured to extract area and/or volume of shapes and number of sides of the shapes based on the 3-D contours of the one or more objects.

7. The system of claim 6, wherein the input vector for a machine learning model includes the area of shapes and the number of sides of the shapes.

8. The system of claim 1, further comprising a tracking module configured to track one or more objects based on the history of the objects in various frames.

9. The system of claim 8, wherein the tracking module is further configured to determine velocity of the one or more objects based on the history of the objects in various frames.

10. The system of claim 1, wherein the pre-processing module configured to stitch heat data from two or more PCAP grids.

11. A method, comprising:
generate a time-series of 3-D heat data frames, each of the 3-D heat data frame including heat data related to a 2-D array of pixels on the grid on the surface of the PCAP sensors and at discrete “z” levels above the PCAP sensors;
pre-processing the time-series of 3-D heat data frames to remove noise from the time series of 3-D heat data frames to generate noiseless PCAP heat data grid;
detecting 2-D contours of one or more objects at each of the discrete “z” levels and to connect points of the 2-D contours at each of the discrete “z” levels to points on the 2-D contours of other of the one or more of the other “z” levels to generate 3-D contours of the one or more objects;
extracting one or more features from the 3-D contours of one or more objects and to generate an input vector for a machine learning model; and
generating in input vector for a machine learning model using the features extracted from the 3-D contours.

12. The method of claim 11, further comprising training at least one of a machine learning (ML) model or a support vector machine (SVM) model using the input vector.

13. The method of claim 11, further comprising entering the input vector into at least one of a trained machine learning (ML) model or a trained support vector machine (SVM) model to generate a series of temporal output frames.

14. The method of claim 11, wherein extracting one or more features comprises extracting one or more image moment invariants based on the 3-D contours of the one or more objects.

15. The device of claim 14, wherein the one or more image moment invariants are Hu moments 1-6.

16. wherein extracting one or more features comprises extracting at least one or area of shapes and number of sides of the shapes based on the 3-D contours of the one or more objects.

17. One or more non-transitory computer-readable storage media encoding computer-executable instructions for executing on a computer system a computer process, the computer process comprising:
receiving a time-series of 3-D heat data frames, each of the 3-D heat data frame including heat data related to a 2-D array of pixels on the grid on the surface of the PCAP sensors and at discrete “z” levels above a grid of plurality of projected capacitance (PCAP) sensors;
pre-processing the time-series of 3-D heat data frames to remove noise from the time series of 3-D heat data frames to generate noiseless PCAP heat data grid;
detecting 2-D contours of one or more objects at each of the discrete “z” levels and to connect points of the 2-D contours at each of the discrete “z” levels to points on the 2-D contours of other of the one or more of the other “z” levels to generate 3-D contours of the one or more objects;
extracting one or more features from the 3-D contours of one or more objects and to generate an input vector for a machine learning model; and
generating in input vector for a machine learning model using the features extracted from the 3-D contours.

18. One or more tangible computer-readable storage media of claim 17, wherein the computer process further comprising at least one of (a) training a machine learning (ML) model using the input vector and (b) entering the input vector into a trained machine learning (ML) model to generate a series of temporal output frames.

19. One or more tangible computer-readable storage media of claim 17, wherein extracting one or more features comprises extracting one or more image moment invariants based on the 3-D contours of the one or more objects.

20. One or more tangible computer-readable storage media of claim 19, wherein the one or more image moment invariants are Hu moments 1-6.
